(19) United States
(12) Patent Application Publication
(10) Pub. No.: US 2011/0088566 A1
(43) Pub. Date: Apr. 21, 2011

(54) Disposable base plate

(76) Inventor: Deborah Ann Doxie, Waukegan, IL (US)

(21) Appl. No.: 12/587,876

(22) Filed: Oct. 15, 2009

(51) Int. Cl. A21B 3/13; A47J 36/02; A47J 36/16

(52) U.S. Cl. 99/426; 99/443 R

(57) ABSTRACT

A disposable base plate for use with all loose bottom and assembly-baking pans, variations include; cheesecake pan, spring-form pan, fluted cake pan, angel food cake pan, tart pan, pie pan, cake pans (mini, round, square, heart shaped, star shaped) and loose bottom pans. A single piece of a two-piece baking pan; an interchangeable platform made of heavy reinforced aluminum foil material, suitable to withstand a baking and freezing environment, to serve as the pan's base. Depending on the pan's design, this base will either interlock to the wall of the pan, or sit within the wall of the pan to form a single unit. The disposable aluminum foil base replaces the traditional anodized aluminum or heavy-gauge steel base. As such, the disposable base is an improvement over the existing base in that it adds convenience, is economical, is intended for use in residential and commercial gas and electric ovens, can be used to bake, serve, and store content, and allows for continuous use of the unit's wall upon removal of finished content. And, it is disposable after one use, while providing the same outstanding baking performance.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention generally relates to baking accessories, and more particularly, to the removable bottom base plate of the assembly-baking pan which, after baking is completed, the pan is disassembled and the food item remains on the pan's base.

2. Description of Prior Art

Assembly-baking pans are specialty pans i.e., spring-form pan, loose bottom pan, assembly-baking mold, cheesecake pan, etc. They are most often used for baking delicate confections, such as cheesecakes, tarts, flourless cakes, and frozen desserts. Traditionally, these pans have been described as round, containing two parts—a removable bottom plate, and cylindrical sidewalls. The two pieces are assembled to form a one-unit pan. This unique two-piece design allows a food item to be easily extricated from the pan without altering the presentation.

The problem associated with the standard assembly-baking pan is the unavailability of additional bases for continuous baking. These pans are supplied with a single base, which allows for only one use of the pan at any given time. When the food item is complete and the two pieces are disassembled, the food item is left resting on the pan's base. The wall of the pan is then available for reuse. Therefore, it would be most desirable to have a replacement bottom base plate; allowing for continuous use of the assembly-baking pan.

The invention/improvement relates to a single use disposable aluminum foil base, a single piece of a two-piece assembly-baking pan. The disposable aluminum foil base replaces the traditional anodized aluminum or heavy-gauge steel base, and offers convenience and reliability. Constructed of recyclable aluminum foil the disposable base is also environmentally safe and efficient. As with other aluminum foil constructed bake ware, the disposable base plate offers even and gentle heat distribution for proper baking and browning. The use of aluminum foil to construct the base makes for a relatively inexpensive product thus, making it disposable.

Prior art U.S. Pat. Nos. 178,105; 497,606; 557,685; 559,788; 572,509; 1,063,144; 1,493,796; 1,727,257; 3,107,587; 3,128,725; 4,644,858; 5,582,389;5,653,359; 5,676,050; 5,678,475; 5,768,980; 7,478,588, are assembly-baking pans in existence, all having either a metal or a glass base, none of which are single-use or disposable.

Prior art U.S. Pat. Nos. 3,021,990; 3,179,036; 3,191,520; 3,196,777; and 3,262,668, are disposable baking pans and containers, none of which include or incorporate the assembly-baking pan or its base.

Prior art U.S. Pat. No. 3,828,966 depicts a baking pan that has a disposable sheet liner of aluminum foil. It is, however, not designed for, or incorporated into the loose bottom pans, assembly-baking pans or molds.

Prior art U.S. Pat. Nos. 4,065,583 and 4,184,421 depicts a pizza pan having a disposable loose bottom-cooking sheet constructed of a flexible metal foil having a webs opening that extend across a perforated center section. This is however different from the present invention, in that it is not designed to accommodate all assembly-baking pans, nor is it geared to the production of baked goods or non-commercial use.

A need, therefore, exists for an improved bottom base plate, which is capable of solving the problems currently associated with assembly-baking pans. The disposable base allows the following changes:
0005. A. Replacement base plate allows the home baker to bake multiple food items without interruption, using the assembly-baking pan
0005. B. Convenience in the form of disposable foil
0005. C. Environmentally safe and efficient product
0005. D. Inexpensive to produce, therefore, inexpensive for the consumer
0005. E. Both oven and freezer safe

Concerning prior art, it is currently recommended that a baking sheet is used in conjunction with the assembly-baking pans providing added support when baking; it is agreed that to give additional support to the bottom of the pan it is necessary to use a baking sheet when using assembled pans and the disposable foil base.

Concerning prior art, some assembly pans leak, the disposable foil base will not add to or take away from this condition. Assembly pan manufacturers offer various techniques that address such conditions. A solution to this condition will however be reviewed/considered in the ultimate design stage of the disposable foil base plate.

References Cited
U.S. Patent Documents

| Number | Date | Name | |
|---|---|---|---|
| 178,105 | May 1876 | L. E. Brown | |
| 497,606 | May 1893 | C. W. Richardson | 249/Dig 1 |
| 557,685 | January 1896 | R. S. Mains | |
| 559,788 | May 1896 | M. L. Perrottet | |
| 572,509 | December 1896 | T. A. Wilson | |
| 1,063,144 | May 1913 | James E. Wallace | |
| 1,154,972 | September 1915 | A. C. Carlson | |
| 1,493,796 | May 1924 | D. N. Anderson | 249/136 |
| 1,567,234 | December 1925 | H. Brucker | |
| 1,727,257 | September 1929 | O. Stratton | |
| 1,713,577 | May 1929 | Wentorf | |
| 1,852,966 | April 1932 | L. Green | |
| 1,862,560 | June 1932 | W. B. Willcutt | |
| 2,222,512 | November 1940 | A. J. Moyen | 99/Dig.15 |
| 2,259,854 | October 1941 | Adrien L. Langel | |
| 2,391,767 | December 1945 | R. F. Beerend | |
| 2,669,914 | February 1954 | W. G. Swaine | |
| 3,107,587 | October 1963 | C. A. Tipton | |
| 3,128,725 | April 1964 | W. C. Becker | |
| 3,179,036 | April 1965 | J. M Luker | |
| 3,191,520 | June 1965 | S. J. Halter | |
| 3,196,777 | July 1965 | J. M. Luker | |
| 3,262,668 | July 1966 | J. M. Luker | |
| 4,065,583 | December 1977 | David William Ahlgren | |
| 4,176,591 | December 1979 | Douglas P Power | |
| 4,184,421 | January 1980 | David William Ahlgren | |
| 4,644,858 | February 1987 | Donna Liotto | |
| 5,398,908 | March 1995 | Erich Kienle | |
| 5,467,697 | November 1995 | Hugo Hunziker | |
| 5,537,917 | July 1996 | Larry W. Schiffer | |
| 5,582,389 | December 1996 | David N. Green | |
| 5,653,359 | August 1997 | Karl Ferdinand | |
| | | Sondermann | |
| 5,676,050 | October 1997 | Ernst Beck | |
| 5,678,475 | October 1997 | Domingo Villar Otero | |
| 5,768,980 | June 1998 | Monika Degen | |
| 7,478,588 | Oct. 20, 2009 | Robert J. Miller | |

### BRIEF SUMMARY OF THE INVENTION

In accordance with the present invention, I provide a one-piece, single-use disposable aluminum foil base plate. The present invention is an improvement on the existing removable bottom plate, loose base or false bottom of all assembly-baking pans, variations are: loose bottom pans, assembly-baking molds, cheesecake pan, spring-form pan, fluted cake pan, angel food cake pan, tart pan, pie pan, cake pans (mini, round, square, heart shaped, star shaped).

The disposable base plate would be constructed of good quality, pollution-free, recyclable aluminum foil material, flat and circular in shape, having an outer peripheral lip/reinforced edge.

The assembly-baking pan contains two parts: a removable bottom plate also called a loose base, base plate or false bottom, and cylindrical sidewalls often referred to as the rim or band. From hereon out, the removable bottom plate, loose base, base plate, or false bottom will be referred to as the “base plate,” and the cylindrical sidewalls, shell, rim or band will be referred to as the “wall.” The wall is independent of and separate from the base. The base is flat and fits cleanly into the groove of the wall, and the pan is closed with a clasp, forming a tight seal. Depending on the pan's design, the base may sit within the body of the wall supported therein. Both designs secure the base inside the wall, forming a complete pan into which content is placed for baking. Once the contents have baked and cooled, the wall and base are separated and the food item is removed.

A common disadvantage of these pans is that they consist of only one base plate, which allows production of only one food item per pan at any given time. If the home baker desires to make several food items, it would be necessary to purchase several assembly-baking pans. An additional base(s) is only available either commercially or through corporate direct special purchases. Once again, the disposable aluminum foil base plate is an improvement from the traditional anodized aluminum or heavy-gauge steel base, allowing uninterrupted production of food items, which is not possible with only one base.

Most baked items must cool to set correctly, while other items require refrigeration. Therefore, it is necessary to wait out the process of complete cooling, chilling, and settling of the food item before transferring it from the base onto an alternate dish. Once these steps are completed, it is possible to resume use of the assembly pan. The disposable aluminum foil base plate allows replacement of the base to form the pan for continued baking, this, all while completed food items cool or are being served. The food item remains on the disposable aluminum foil base plate allowing for immediate reuse of the assembly pan simply by attaching another disposable base.

The disposable aluminum foil base plate also allows for easy gift giving and sharing, which is extremely convenient during the holiday season. Food items can be prepared and given as gifts, or shared during a social function without having to disturb or transfer the items from their original state. In addition, the baking pans never have to be retrieved, and the home baker is never left with an incomplete baking pan.

In the commercial kitchen, the disposable aluminum foil base plate replaces the cardboard round, allowing the food item to remain on the foil base never risking damage to the item due to transfer. Food items can be wrapped, refrigerated, stored, and/or shipped on the disposable base, without ever needing to be transferred.

The disposable aluminum foil base plate allows for continuous baking, freezing, decorating, serving, storing, sharing, and gift giving, all in one pan.

The disposable aluminum foil base plate also provides a more sanitary cooking environment, easy cleanup, is safe for both oven and freezer, and is relatively inexpensive.

The present invention also lends itself to other various shapes and sizes, including sheet cake, loaf, muffin, cheesecake pan, spring-form pan, fluted cake pan, angel food cake pan, tart pan, pie pan, tubular pan, molds, cupcakes, cake pans (mini, round, square, heart shaped, star shaped) and other irregular shapes.

It is obvious that minor adjustments may be made in the form and construction of the invention without departing from the material, operation, and character of the invention. It is not, however, desired to confine the invention to the exact form illustrated and described, but it is desired to include all such as is properly come within the scope claimed.

### BRIEF DESCRIPTION OF THE SEVERAL VIEWS OF THE DRAWING

FIG. 1 is the top view of the disposable foil base plate according to the present invention.

FIG. 2 is an elevation view of the disposable foil base according to the present invention, having a thickness of about ½ inch (12.7 mm), having stiffness, equivalent to the traditional Anodized aluminum or heavy-gauge steel base, with a reinforced edge of ⅛ inch (3.2 mm).

FIG. 3 is an exposed view of the disposable foil base plate according to the present invention in relation to the assembly-baking pan.

FIG. 4 is a view of a food item displayed on a disposable foil base plate according to the present invention.

FIGS. 5 & 6 are additional views of disposable foil base plate according to the present invention in relation to the assembly-baking pan, baker able to insert additional disposable base plate and continue baking.

### DETAILED DESCRIPTION OF THE INVENTION

Referring now to the drawings wherein the illustrations are for purposes of showing the preferred embodiments of the invention only, and not for purposes of limiting the same.

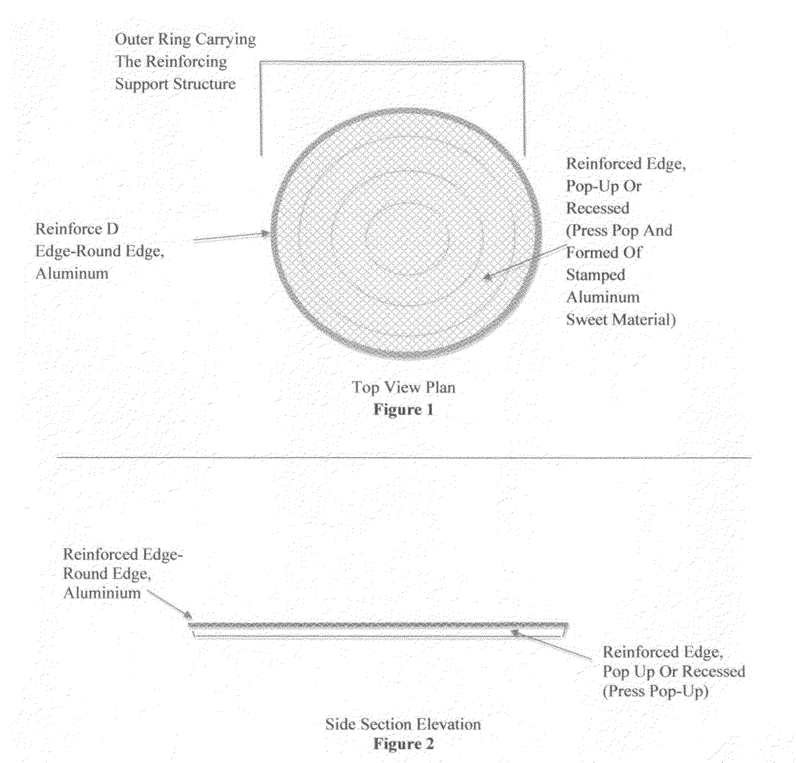

Referring to FIG. 1, showing a top view of the present invention wherein said portion is a one-piece interchangeable disposable base plate constructed of good quality, pollution-free, recyclable aluminum foil material suitable to withstand both a baking and freezing environment disk shape, having a diameter of about six to ten inches, 47.5 mm in thickness. While the preferred embodiment describes a base that is generally circular, it is evident that the invention can be applied to other base shapes as well.

Referring to FIG. 2, showing an elevation view of the disposable foil base plate according to the present invention 47.5 mm in thickness, the figure details the reinforced edge/peripheral lip extending about the outer periphery of the base.

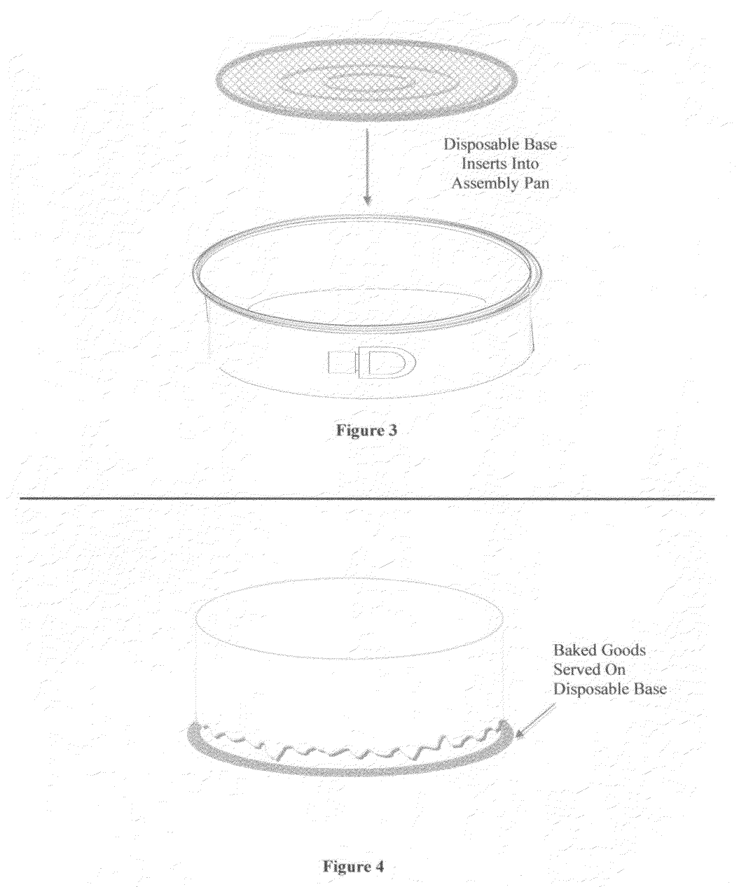

Referring to FIG. 3, showing the assembly process of the disposable foil base plate in relation to the assembly-baking pan, though pictured with the spring-form pan, this invention will lend itself to other bake ware forms.

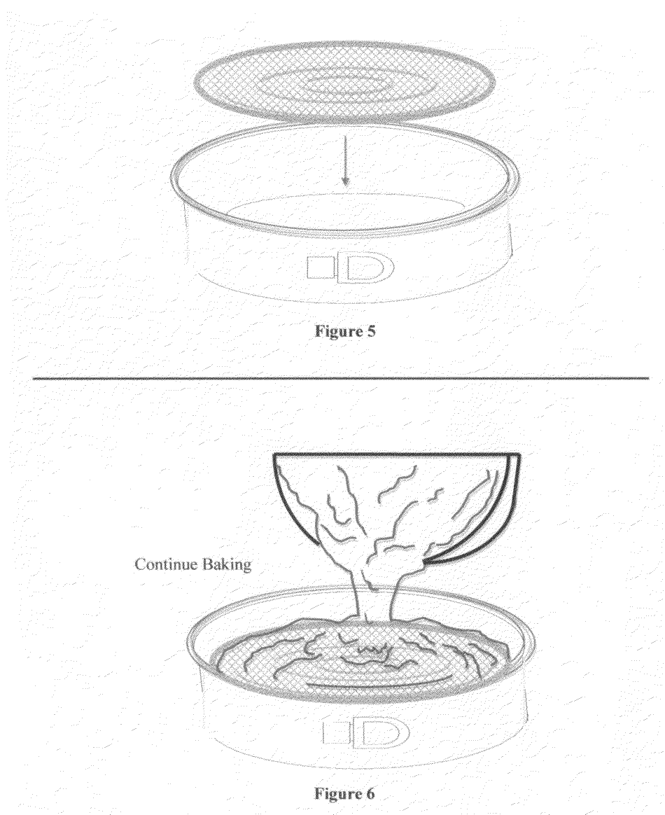

Referring to FIGS. 4, 5 and 6, a view of a food item displayed on a disposable foil base plate after baking, the baker is then able to insert another disposable base and continue baking.

It is therefore a principal object of the present invention to provide additional base plate(s) to effectively be utilized in conjunction with all assembly baking pans.

It is another object of the present invention to provide a base plate constructed of aluminum foil material making it disposable, environmentally safe, cost-effective and convenient.

It is another object of the present invention to provide a base plate, which can be quickly and easily refilled with another food item in a minimum length of time allowing for continued use of the assembly-baking pan.

It is another object of the present invention to eliminate the transfer of the food item from the base plate to an alternate serving platter in providing a disposable base plate that doubles as a serving piece.

It is another object of the present invention to provide a base plate that may be produced in a variety of shapes and sizes to effectively be utilized in conjunction with all assembly-baking pans.

It is another object of the present invention to provide a base plate, which is of a durable and reliable construction.

It is another object of the present invention to provide a base plate that is disposable, eliminating cleaning time.

It is another object of the present invention to provide a base plate, which can be economically produced for both commercial and non-commercial use.

It is another object of the present invention to provide a base plate that is easily manufactured and marketed.

It is another object of the present invention to provide a base plate that performs effectively in both an oven and freezer environment.

Although the invention has been described with particular reference to specific embodiments thereof, it will be readily understood by those skilled in the art that various modifications and variations may be resorted to without department from the spirit and scope of the invention as defined by the appended claims.

I claim:

1. A one-piece disposable aluminum foil base plate.

2. The one-piece disposable aluminum foil base plate of claim 1, having a peripheral lip/reinforced edge that fits into the accommodating indent formed at a wall's edge in accordance with most assembly-baking pans, providing a generally sealed connection at the mating surfaces of the disposable base and the wall. The disposable base serves as the base/bottom of all assembly-baking pans by either attaching to the wall or sitting within the body of the pan to form one unit, placement of said base depends on the design of the pan.

3. The one-piece disposable aluminum foil base plate of claim 1 wherein said base is made from a one-piece reinforced aluminum foil material having a thickness of about ½ inch (12.7 mm), having stiffness equivalent to the traditional anodized aluminum or heavy-gage steel base, with a reinforced edge of ⅛ inch (3.2 mm); suitable to withstand a baking and freezing environment.

4. The one-piece disposable aluminum foil base plate of claim 1, the disk dimensions are (L×W×H): 9×9×0.75 inches, the said one-piece disposable aluminum foil base is circular and 9-inches in diameter, being the most common, additional dimensions are 8″, 10″, 12″, etc.

5. The one-piece disposable aluminum foil base plate of claim 1 is designed to be used within all assembly-baking pans, variations are: loose bottom pans, assembly-baking molds, cheesecake pan, spring-form pan, fluted cake pan, angel food cake pan, tart pan, pie pan, loaf, ring, cupcake, muffins, cake pans (mini, round, square, oval, rectangular, heart shaped, star shaped), and various other irregular shapes. This base can be used for baking, freezing, serving, and storing, and is disposable after a single use.
